(19) United States
(12) Patent Application Publication
(10) Pub. No.: US 2015/0098054 A1
(43) Pub. Date: Apr. 9, 2015

(54) Low Frame Eyeglasses

(71) Applicant: Mike Sidler, Ovilla, TX (US)

(72) Inventor: Mike Sidler, Ovilla, TX (US)

(21) Appl. No.: 14/046,784

(22) Filed: Oct. 4, 2013

(51) Int. Cl. G02C 7/10; G02C 1/04

(52) U.S. Cl. CPC G02C 7/10; G02C 1/04
USPC 351/103

(57) ABSTRACT

An eyeglasses for a user as may include an opposing pair of ear support arms to support the eyeglass; an opposing pair of concave lens support portions to connect to the ear support arms to lower the center of gravity of the eyeglass and an opposing pair of lens connected to the concave lens support portions

### FIELD OF THE INVENTION

The present invention relates to eyeglasses.

### BACKGROUND

Eyeglasses and sunglasses have been used to enhance vision and provide protection from the harmful effects of the sun. An important consideration for eyeglasses and sunglasses is the stability of the eyeglasses or sunglasses especially when the user is wearing the eyeglasses or sunglasses on top of the head. If the eyeglasses or sunglasses become unstable and fall off the top of the head of the user, the eyeglasses or sunglasses may be subject to considerable damage or loss.

Reflective glare from the cheeks of the user of eyeglasses or sunglasses may reflect into the eyes of the user. This reflective glare may be dangerous to the user or may be significantly irritating to the user.

### SUMMARY

An eyeglasses for a user as may include an opposing pair of ear support arms to support the eyeglass; an opposing pair of concave lens support portions to connect to the ear support arms to lower the center of gravity of the eyeglass and an opposing pair of lens connected to the concave lens support portions

The lens may include a curved edge surface and an inclined edge surface and the concave lens support portions may only connect with the curved edge surface of the lens.

The concave support lens portion may not connected with the inclined edge surface.

The eyeglasses may reduce glare from the cheekbones of the user.

The ear support arms may include ear pads to increase the holding power of the frame.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a back perspective view of the eyeglasses of the present invention;

FIG. 2 illustrates a front perspective view of the eyeglasses of the present invention;

FIG. 3 illustrates a front view of the eyeglasses of the present invention;

FIG. 4 illustrates a side view of the eyeglasses of the present invention;

FIG. 5 illustrates a top view of the eyeglasses of the present invention;

FIG. 6 illustrates a front view of the lens of the present invention.

### DETAILED DESCRIPTION

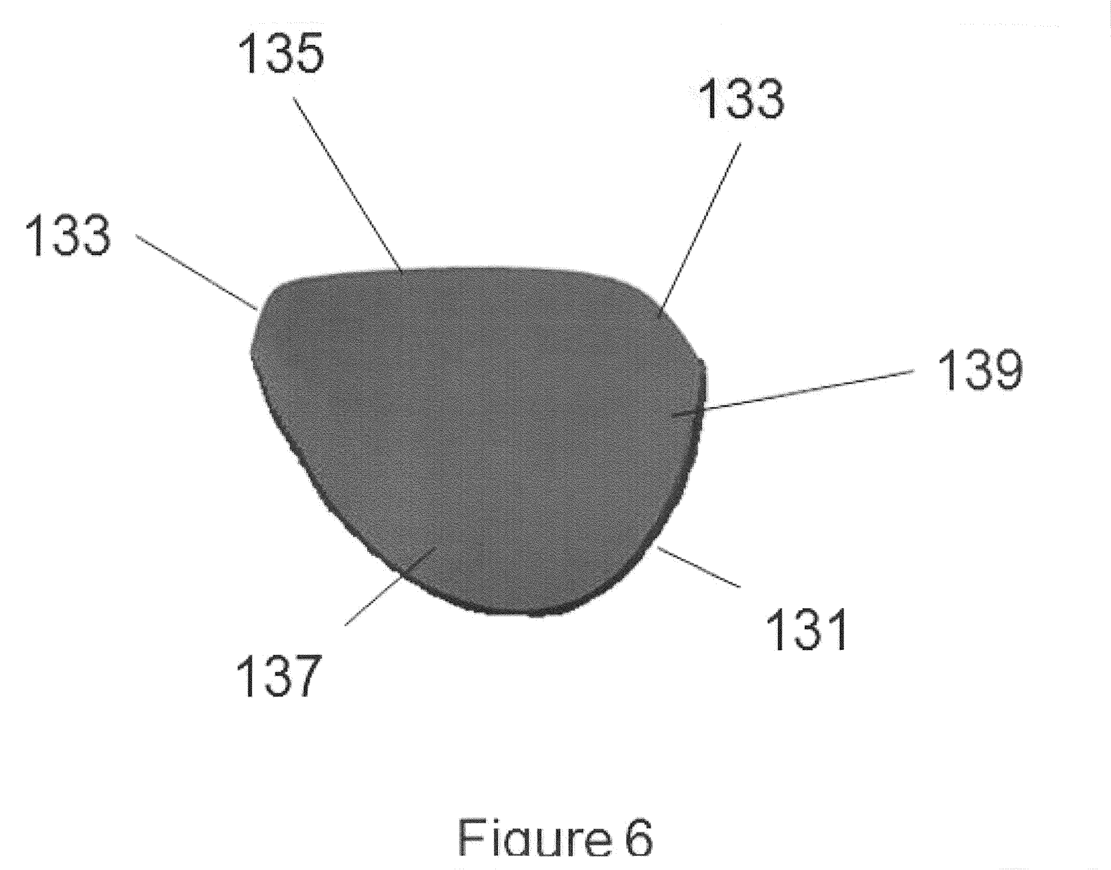

FIG. 6 illustrates a front view of the lens 130 of the present invention.

The lens 130 of the present invention may include a front surface 137 which may be opposed to a back surface 139 and which may be connected to the curved edge surface 131, the inclined edge surface 133 and the horizontal edge surface 135. The back surface 139 may be connected to the curved edge surface 131, the inclined edge surface 133 and the horizontal edge surface 135. The inclined edge surface 133 which may be a pair of opposing inclined edge surfaces 133 may be connected to the curved edge surface 131 and the horizontal edge surface 135. The horizontal edge surface 135 may be connected between the opposing inclined edge surfaces 135. The curved edge surface 131 (a first edge surface) may be connected between the opposing inclined edge surface 133 (a second edge surface). The lens 131 may be transparent or translucent and may be clear or colored.

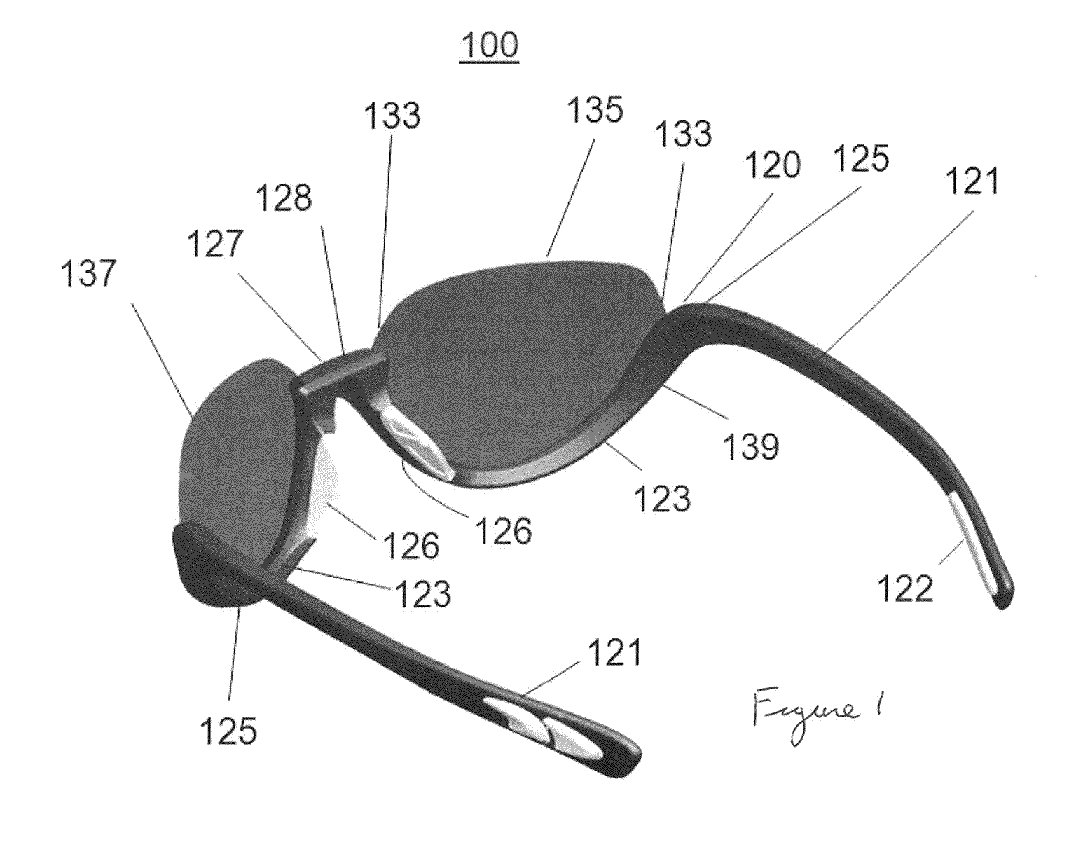

FIG. 1 illustrates a perspective view of the low frame 120 and a pair of opposing lens 130 to form an eyeglasses or sunglasses.

The low frame 120 may include a pair of opposing ear support arms 121 which may be slightly curved or may be substantially straight in order to exert pressure on the temple of the user or may extend over the ear of the user. Each of the ear support arms 121 may be rigidly connected or may be pivotably connected by virtue of a pair of opposed hinges 125 to a pair of opposed concave lens low frame support portions 123 (a pair of opposed low frame) which may be connected to a nose support 127. The nose support 127 may include a nose horizontal portion 128 to connect the concave lens low frame support portions 123 and may include a nose rest portion 126 which may be connected to the concave lens low frame support portion 123 in order to provide a support for the nose of the user. The concave lens low frame support portions 125 may connect to the curved edge surface 131 (a first edge surface) of the lens 130.

The eyeglasses 100 as illustrated in FIG. 1 may include a frame 120 and a pair of opposing lens 130. The frame 120 may include a pair of opposing ear support arms 121 which may extend from the concave lens low frame support portion 123 at approximately 90° and which may be pivotably connected (by hinges 125) to the concave lens low frame support portion 123. The ear support arms 121 may be slightly curved or substantially straight and may extend sufficiently to reach the ear.

The concave lens low frame support portion 123 may be connected to and support the lens 130 and may cooperate with the curved edge surface 131 and may not cooperate or connect with the inclined edge 133.

The low frame 120 lowers the center of gravity of the eyeglasses 100 below the vertical center of the eyeglasses 100. The lower center of gravity enhances the stability of the sunglasses on the head of the user.

The ear support arms 121 may include ear pads 122 which may be formed from rubber, plastic or other appropriate material in order to increase the friction (holding power) of the ear support arms 121 and the head of the user around the ear of the user.

Additionally, the low frame 120 reduces the reflective glare from the cheekbones of the user.

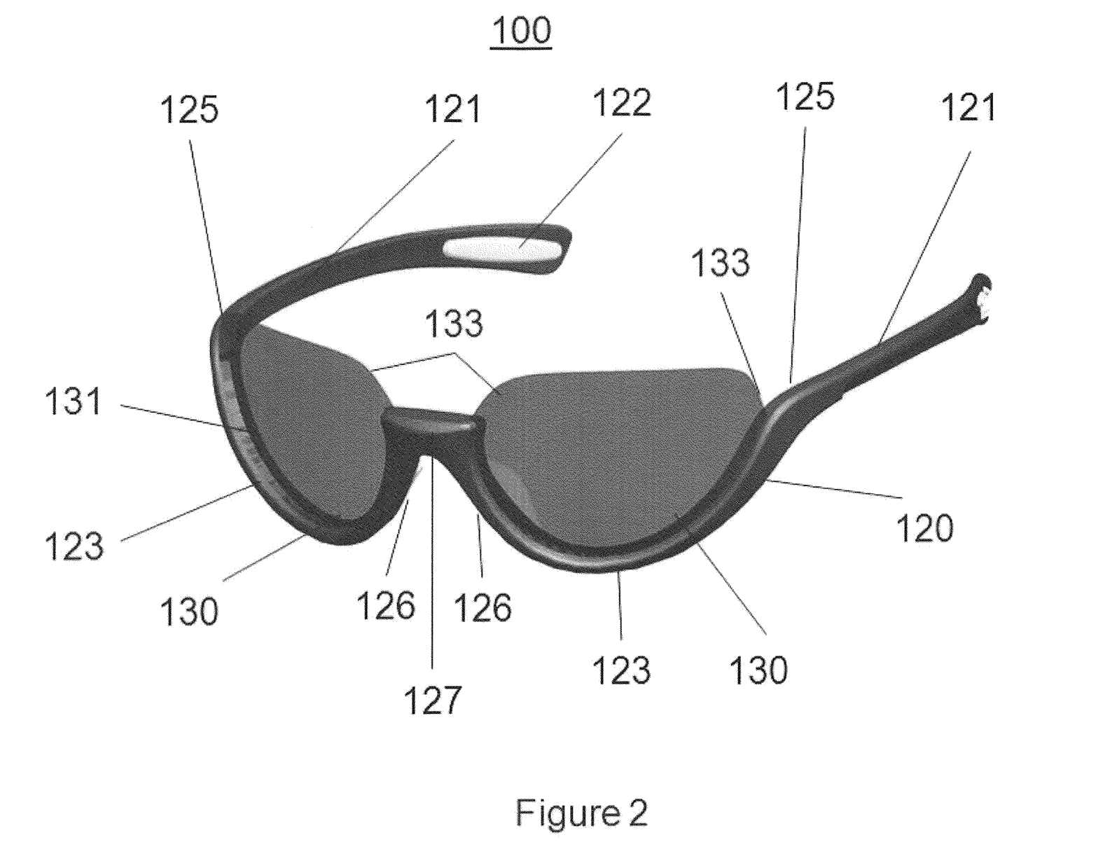

FIG. 2 illustrates a front perspective view of the frame 120 and a pair of opposing lens 130 to form an eyeglasses or sunglasses.

The frame 120 may include a pair of opposing ear support arms 121 which may be slightly curved or may be substantially straight in order to exert pressure on the temple of the user or may extend over the ear of the user. Each of the ear support arms 121 may be rigidly connected or may be pivotably connected by virtue of a pair of opposed hinges 125 to a pair of opposed concave lens support portions 123 which may be connected to a nose support 127. The nose support 127 may include a nose horizontal portion 128 to connect the concave lens support portions 123 and may include a nose rest portion 126 which may be connected to the concave lens support portion 123 in order to provide a support for the nose of the user. The concave lens support portions 125 may connect to the curved edge surface 131 of the lens 130.

The eyeglasses 100 as illustrated in FIG. 2 may include a frame 120 and a pair of opposing lens 130. The frame 120 may include a pair of opposing ear support arms 121 which may extend from the concave lens support portion 123 at approximately 90° and which may be pivotably connected (by hinges 125) to the concave lens support portion 123. The ear support arms 121 may be slightly curved or substantially straight and may extend sufficiently to reach the ear.

The concave lens support portion 123 may be connected to and support the lens 130 and may cooperate with the curved edge surface 131 and may not cooperate or connect with the inclined edge 133.

The low frame 120 lowers the center of gravity of the eyeglasses 100 below the vertical center of the eyeglasses 100. The lower center of gravity enhances the stability of the sunglasses on the head of the user.

The ear support arms 121 may include ear pads 122 which may be formed from rubber, plastic or other appropriate material in order to increase the friction (holding tower) of the ear support arms 121 and the head of the user around the ear of the user.

Additionally, the low frame 120 reduces the reflective glare from the cheekbones of the user.

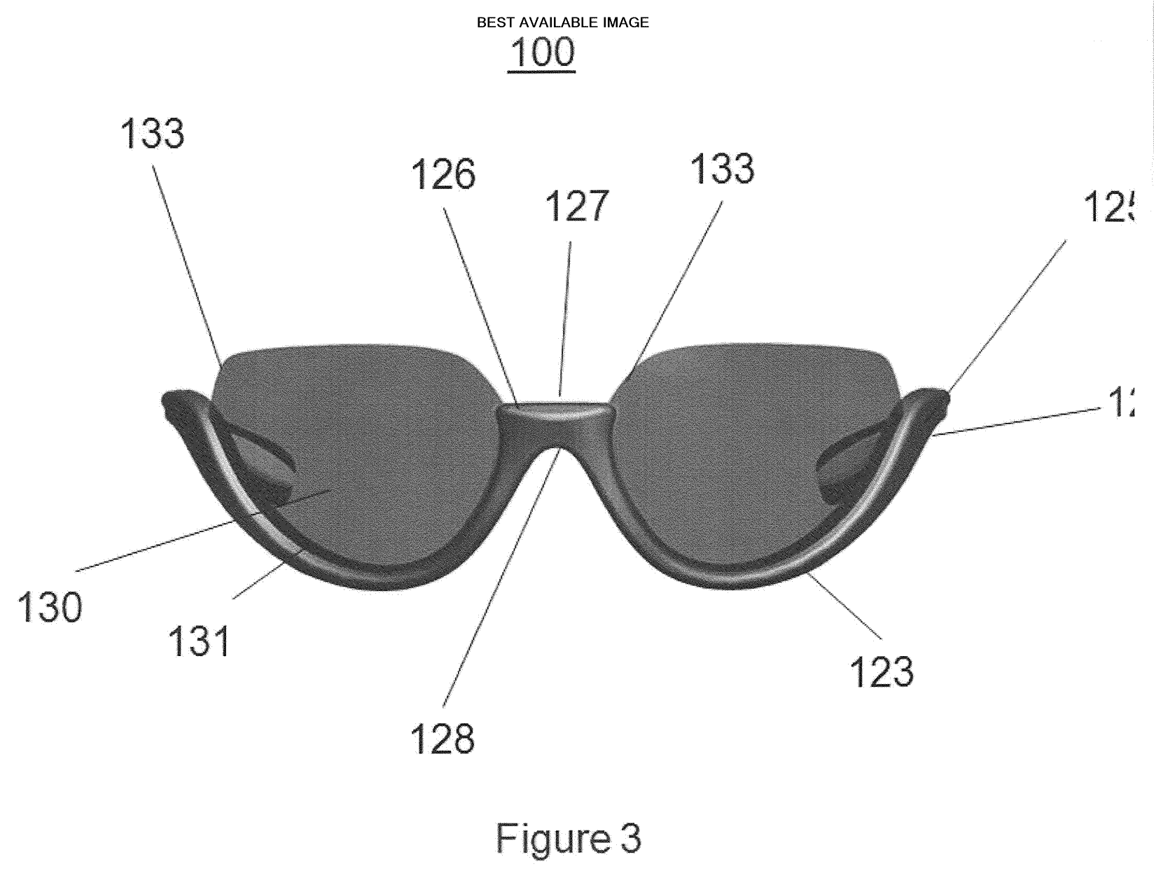

FIG. 3 illustrates a front view of the frame 120 and a pair of opposing lens 130 to form an eyeglasses or sunglasses.

The frame 120 may include a pair of opposing ear support arms 121 which may be slightly curved or may be substantially straight in order to exert pressure on the temple of the user or may extend over the ear of the user. Each of the ear support arms 121 may be rigidly connected or may be pivotably connected by virtue of a pair of opposed hinges 125 to a pair of opposed concave lens support portions 123 which may be connected to a nose support 127. The nose support 127 may include a nose horizontal portion 128 to connect the concave lens support portions 123 and may include a nose rest portion 126 which may be connected to the concave lens support portion 123 in order to provide a support for the nose of the user. The concave lens support portions 125 may connect to the curved edge surface 131 of the lens 130.

The eyeglasses 100 as illustrated in FIG. 3 may include a frame 120 and a pair of opposing lens 130. The frame 120 may include a pair of opposing ear support arms 121 which may extend from the concave lens support portion 123 at approximately 90° and which may be pivotably connected (by hinges 125) to the concave lens support portion 123. The ear support arms 121 may be slightly curved or substantially straight and may extend sufficiently to reach the ear.

The concave lens support portion 123 may be connected to and support the lens 130 and may cooperate with the curved edge surface 131 and may not cooperate or connect with the inclined edge 133.

The low frame 120 lowers the center of gravity of the eyeglasses 100 below the vertical center of the eyeglasses 100. The lower center of gravity enhances the stability of the sunglasses on the head of the user.

The ear support arms 121 may include ear pads 122 which may be formed from rubber, plastic or other appropriate material in order to increase the friction (holding tower) of the ear support arms 121 and the head of the user around the ear of the user.

Additionally, the low frame 120 reduces the reflective glare from the cheekbones of the user.

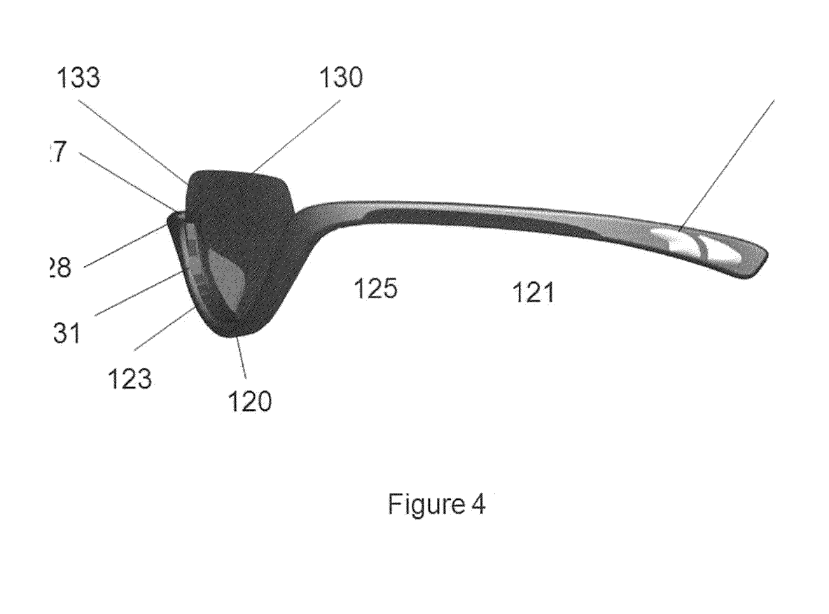

FIG. 4 illustrates a side view of the frame 120 and a pair of opposing lens 130 to form an eyeglasses or sunglasses.

The frame 120 may include a pair of opposing ear support arms 121 which may be slightly curved or may be substantially straight in order to exert pressure on the temple of the user or may extend over the ear of the user. Each of the ear support arms 121 may be rigidly connected or may be pivotably connected by virtue of a pair of opposed hinges 125 to a pair of opposed concave lens support portions 123 which may be connected to a nose support 127. The nose support 127 may include a nose horizontal portion 128 to connect the concave lens support portions 123 and may include a nose rest portion 126 which may be connected to the concave lens support portion 123 in order to provide a support for the nose of the user. The concave lens support portions 125 may connect to the curved edge surface 131 of the lens 130.

The eyeglasses 100 as illustrated in FIG. 4 may include a frame 120 and a pair of opposing lens 130. The frame 120 may include a pair of opposing ear support arms 121 which may extend from the concave lens support portion 123 at approximately 90° and which may be pivotably connected (by hinges 125) to the concave lens support portion 123. The ear support arms 121 may be slightly curved or substantially straight and may extend sufficiently to reach the ear.

The concave lens support portion 123 may be connected to and support the lens 130 and may cooperate with the curved edge surface 131 and may not cooperate or connect with the inclined edge 133.

The low frame 120 lowers the center of gravity of the eyeglasses 100 below the vertical center of the eyeglasses 100. The lower center of gravity enhances the stability of the sunglasses on the head of the user.

The ear support arms 121 may include ear pads 122 which may be formed from rubber, plastic or other appropriate material in order to increase the friction (holding tower) of the ear support arms 121 and the head of the user around the ear of the user.

The frame 120 may be formed from plastic, metal, wood or other appropriate material.

The lens maybe formed from plastic, glass or other appropriate material.

Additionally, the low frame 120 reduces the reflective glare from the cheekbones of the user.

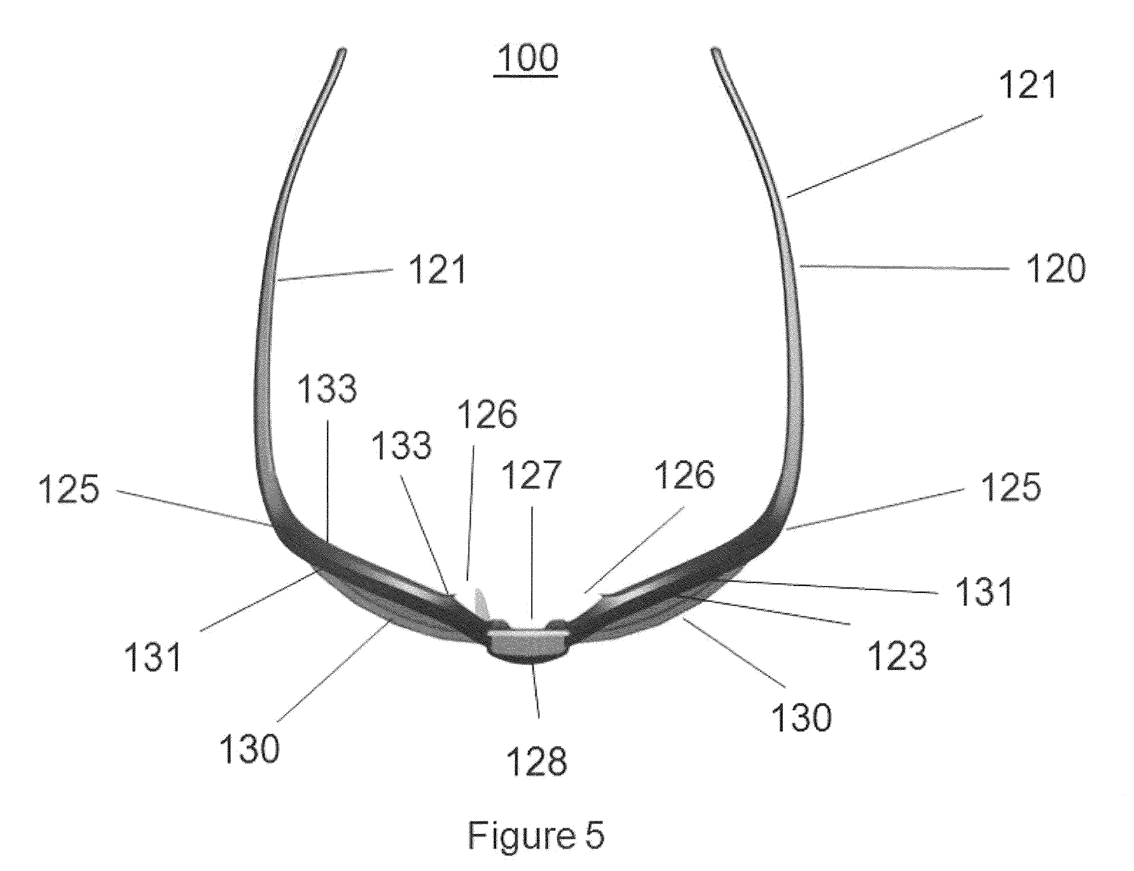

FIG. 5 illustrates a top view of the frame 120 and a pair of opposing lens 130 to form an eyeglasses or sunglasses 100. The frame 120 and the pair of opposing lens 130 of the eyeglasses or sunglasses 100 may be substantially U-shaped.

The frame 120 may include a pair of opposing ear support arms 121 which may be slightly curved or may be substantially straight in order to exert pressure on the temple of the user or may extend over the ear of the user. Each of the ear support arms 121 may be rigidly connected or may be pivotably connected by virtue of a pair of opposed hinges 125 to a pair of opposed concave lens support portions 123 which may be connected to a nose support 127. The nose support 127 may include a nose horizontal portion 128 to connect the concave lens support portions 123 and may include a nose rest portion 126 which may be connected to the concave lens support portion 123 in order to provide a support for the nose of the user. The concave lens support portions 125 may connect to the curved edge surface 131 of the lens 130.

The eyeglasses 100 as illustrated in FIG. 5 may include a frame 120 and a pair of opposing lens 130. The frame 120 may include a pair of opposing ear support arms 121 which may extend from the concave lens support portion 123 at approximately 90° and which may be pivotably connected (by hinges 125) to the concave lens support portion 123. The ear support arms 121 may be slightly curved or substantially straight and may extend sufficiently to reach the ear.

The concave lens support portion 123 may be connected to and support the lens 130 and may cooperate with the curved edge surface 131 and may not cooperate or connect with the inclined edge 133.

The low frame 120 lowers the center of gravity of the eyeglasses 100 below the vertical center of the eyeglasses 100. The lower center of gravity enhances the stability of the sunglasses on the head of the user.

The ear support arms 121 may include ear pads 122 which may be formed from rubber, plastic or other appropriate material in order to increase the friction (holding tower) of the ear support arms 121 and the head of the user around the ear of the user.

The frame 120 may be formed from plastic, metal, wood or other appropriate material.

The lens maybe formed from plastic, glass or other appropriate material.

Additionally, the low frame 120 reduces the reflective glare from the cheekbones of the user.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) An eyeglasses for a user, comprising:
an opposing pair of ear support arms to support the eyeglass;
an opposing pair of first lens low frame support portions to connect to the ear support arms to lower the center of gravity of the eyeglass;
an opposing pair of lens connected to the first lens low frame support portions
wherein the lens includes a curved edge surface and an second edge surface and wherein first lens low frame support portions only connect with the curved edge surface of the lens.

2) An eyeglasses for a user as in claim 1, where in the first support low frame lens portion do not connected with the second edge surface.

3) An eyeglasses for a user as in claim 1, wherein the eyeglasses reduce glare from the cheekbones of the user.

4) An eyeglasses for a user as in claim 1, wherein the ear support arms includes ear pads to increase the holding power of the frame.
